(19) United States
(12) Patent Application Publication
(10) Pub. No.: US 2026/0067023 A1
(43) Pub. Date: Mar. 5, 2026

(54) SYSTEM AND METHOD FOR PRECISION BLOCKING OF PERSONAL AREA NETWORK PICONETS

(71) Applicant: SR Technologies, Inc., Sunrise, FL (US)

(72) Inventors: Nikolaos Glantzis, Sunrise, FL (US); Bradley Vansant, Sunrise, FL (US)

(21) Appl. No.: 19/307,974

(22) Filed: Aug. 22, 2025

Related U.S. Application Data
(60) Provisional application No. 63/688,173, filed on Aug. 28, 2024.

(51) Int. Cl. H04K 3/00; H04L 69/22

(52) U.S. Cl. CPC H04K 3/40; H04L 69/22

(57) ABSTRACT

A method and apparatus for precision blocking in Bluetooth target piconets is described. A Bluetooth monitoring station is used to receive packets on all 79 channels simultaneously. The address codes for a set of target piconets may be received. The access codes are decoded and examined for all received packets. If a set of packets is identified from the received packets, each identified packet having an access code within the set of target access codes, a blocking transmission is sent on that same channel of the identified packet. A start time of the blocking transmission is determined based on a start time of the identified packet, and the blocking transmission is initiated at the estimated start time on the channel, so as to cause a denial of service or a service degradation to that piconet.

### CROSS REFERENCE TO RELATED APPLICATION

This application claims the benefit of U.S. Provisional Patent Application No. 63/688,173, titled “System and Method for Precision Blocking of Personal Area Network Piconets,” and filed on Aug. 28, 2024, the entire content of which is incorporated by reference herein.

### TECHNICAL FIELD

The present disclosure relates to wireless communications and in particular to a method and monitoring station for identifying and/or interrupting specific packets being communicated to or from target Classic Bluetooth Basic Rate (BR) devices.

### BACKGROUND

The Bluetooth system is specified in “Specification of the Bluetooth® System, Covered Core Package Version: 5.0,” with a Publication Date of Dec. 6, 2016 (“Specification of the Bluetooth® System”). Bluetooth operates in the unlicensed Industrial, Scientific, and Medical (ISM) band from 2.400 to 2.4835 GHz. Classic Bluetooth Basic Rate (BR) employs Gaussian Frequency-Shift Keying (GFSK) as the primary modulation scheme, while Classic Bluetooth Enhanced Data Rate (EDR) incorporates differential phase-shift keying (DPSK) for increased throughput. BR may occupy any of 79 radio frequency (RF) channels, spaced by 1 MHz. The nominal channel symbol rate is 1 MHz with a nominal channel symbol duration of 1 microsecond (μs).

A more complete understanding of the present embodiments, and the attendant advantages and features thereof, will be more readily understood by first describing relevant Bluetooth® SR system details. A more complete description can be obtained by reference to the Specification of the Bluetooth® System, the entirety of which is incorporated herein by reference.

Bluetooth® is a time division multiplex (TDM) system that includes a “Master” device, which initiates an exchange of data, and a “Slave” device which responds to the Master. The TDM slot duration is 625 μs, and the maximum payload length is such that certain packet types may extend up to five slots in length. Each device will hop to an RF channel once per packet and Slave devices will utilize the timing of their Master to hop in synchronization. Accordingly, the Master and Slave form a unique piconet.

There are two basic types of data packets and links: Asynchronous Connectionless (ACL) and Synchronous Connection Oriented (SCO). ACL is used for data communications with just one ACL link per device pair. SCO is used for real time audio links, and each device may support up to 3 SCO links at one time.

FIG. 1 is a schematic diagram of a general format 100 of a Classic Bluetooth BR packet type. Every packet starts with an Access Code 110. The access code is a preamble followed by a sync word. The sync word is a 64-bit code word derived from a 24 bit address lower address part (LAP). The Access Code 110 uniquely identifies the piconet. If a packet header follows, the access code is 72 bits long, otherwise the access code is 68 bits long and is known as a shortened access code. For any packet not comprised solely of a shortened Access Code, the Access Code 110 is followed by a 54-bit GFSK Packet Header 115, which is generated by encoding an 18-bit information field using a rate 1/3 repetition code. The Header 115 may be followed by the payload 120. The length of the payload depends upon the type of packet being transmitted.

FIG. 2 is a schematic diagram showing the information fields of the Header 115 format shown in FIG. 1. Header 115 starts with the logical transport address for the packet, LT_ADDR 210. The TYPE code 211 follows which specifies which packet type is used. The FLOW bit 212 is used for flow control of packets over the ACL logical transport. The acknowledgement indication ARQN bit 213 is used to inform the source of a successful transfer of payload data and can be a positive acknowledgement, ACK, or a negative acknowledgement NAK. The sequential numbering SEQN bit 214 is used to order the data packet stream. Finally, each header has a header-error-check HEC 215 to check the Header integrity. If the HEC 215 does not check, the entire packet is discarded.

In certain circumstances, it may be desired to interrupt communications to and/or from a master and a slave device. Such interruption of communication is known as “denial of service” (DoS). Many DoS methods are known, but because Bluetooth uses encrypted frequency hopping, specific piconet packet exchanges are difficult to follow and as such simple jamming DoS may only block communications on a specific frequency channel, or over the entire bandwidth blocking all communication in that area. It is noted that not all DoS actions are nefarious. For example, a DoS action may be a legally approved action. In this context, a more precise form of DoS may be used as opposed to a broadband jamming. The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a schematic diagram of a general format of a Classic Bluetooth Basic Rate (BR) packet type, in accordance with some embodiments.

FIG. 2 is a schematic diagram showing the information field of a header format shown in FIG. 1, in accordance with some embodiments.

FIG. 3 is a block diagram of an example of a Bluetooth monitoring station that can be used to monitor signals across 79 channels, in accordance with some embodiments.

FIG. 4 is a diagram that shows examples of blocking transmissions and how they may be transmitted in relation to the timing of a general format of the Classic Bluetooth BR packet type, in accordance with some embodiments.

FIG. 5 is a flowchart diagram of an example process for precision blocking of Bluetooth piconets, in accordance with some embodiments.

FIG. 6 is a flowchart diagram of another example process for precision blocking of Bluetooth piconets, in accordance with some embodiments.

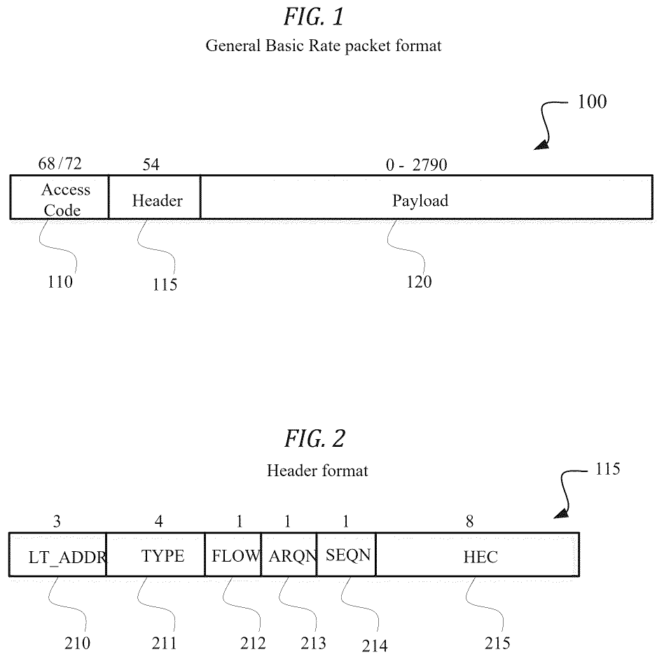

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### SUMMARY

The subject matter described herein relates to a method and monitoring station for identifying and/or interrupting specific packets being communicated on one or more target Bluetooth piconets. In some embodiments, blocking transmissions are timed so as to cause a denial of service (DoS) or a service degradation (SD) to a target piconet. A blocking transmission refers to the transmission of a radio frequency signal on a frequency channel that is currently in use by the target piconet. In some embodiments, the blocking transmission may be initiated after detection of an access code of a packet and within a predetermined microsecond timing window that is determined based on the packet's transmission start time. The blocking transmission may interfere with at least a portion of the packet, either (i) the packet header, to cause a header error check (HEC) failure and thereby force the packet to be discarded, or (ii) the payload portion to corrupt the data therein. The blocking transmission has a duration limited to the remainder of the time slot in which the packet is received, enabling selective disruption of the target piconet while minimizing interferences with other piconets operating on different channels.

More specifically, for precision blocking in Bluetooth piconets, a set of target access codes for a set of target piconets is received. Multiple packets on multiple channels are received, where each packet includes an access code. The access code for each packet is decoded. A set of packets, whose access codes are within the set of target access codes, is identified from the multiple packets. For each identified packet in the set of packets, a start time of a blocking transmission is estimated based on a start time of the identified packet. The blocking transmission is initiated at the estimated start time on each channel associated with each identified packet.

The present disclosure also teaches a monitoring system configured to implement precision blocking in Bluetooth target piconets. In some embodiments, the monitoring system comprises an antenna, a packet surveyor, and one or more processors. The antenna is configured to receive multiple signals on multiple channels. The packet surveyor is configured to demodulate each signal in the multiple signals received on each channel of the multiple channels and extract access codes from each packet of the multiple packets contained in the multiple signals. The one or more processors are configured to receive a set of target access codes for a set of target piconets. The one or more processors are also configured to identify, from the multiple packets, a set of packets whose access codes are within the set of target access codes. The one or more processors are configured to estimate, for each identified packet in the set of packets, a start time of a blocking transmission based on a start time of the identified packet, and initiate the blocking transmission at the estimated start time on each channel associated with each identified packet.

The above and other preferred features, including various novel details of implementation and combination of events, will now be more particularly described with reference to the accompanying figures and pointed out in the claims. It will be understood that the systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each feature described herein, and each combination of two or more such features, is included within the scope of the present disclosure provided that the features included in such a combination are not mutually inconsistent. In addition, any feature or combination of features may be specifically excluded from any embodiment of any of the present inventions.

The foregoing summary, including the description of some embodiments, motivations therefor, and/or advantages thereof, is intended to assist the reader in understanding the present disclosure, and does not in any way limit the scope of any of the claims

### DETAILED DESCRIPTION

Apparatus and methods are disclosed for packet detection and precision blocking of wireless devices and piconets based upon Classic Bluetooth Basic Rate (BR). In one embodiment of this disclosure, packets may be exchanged between wireless devices (e.g., master and slave) while the packets are constantly monitored by a Bluetooth monitoring station. The Bluetooth monitoring station described herein may generally comply with the Specification of the Bluetooth® System, but may be modified to enable the monitoring of all transmitted packets across 79 channels. In addition, the Bluetooth monitoring station can be further configured to simultaneously transmit on one or more channels.

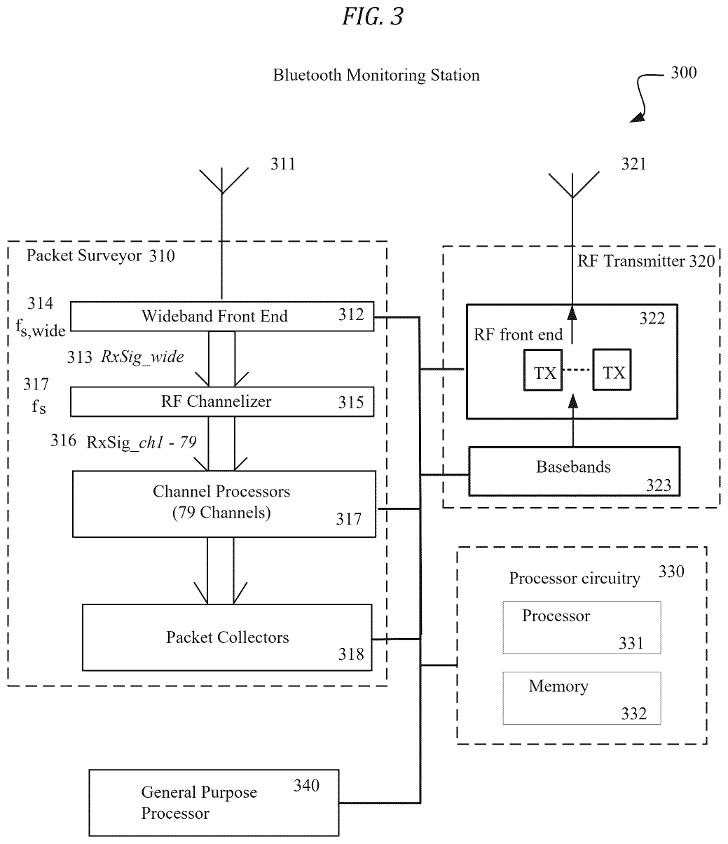

FIG. 3 is a block diagram of an example of a Bluetooth monitoring station 300 that can be used to monitor signals across all 79 channels. In some embodiments, Bluetooth monitoring station 300 includes antenna 311, packet surveyor 310, antenna 321, radio frequency (RF) transmitter 320, processing circuitry 330, and general purpose processor 340.

In some embodiments, packet surveyor 310 includes a wideband front end 312, an RF channelizer 315, channel processors 317, and packet collectors 318. Wideband front end 312 may perform functions such as low noise amplification, filtering, and frequency down conversion to condition signals received from antenna 311 for inputting to the RF channelizer 315. The output from wideband front end 312 can include a number of sampled, complex, wideband signals, RxSig_wide 313, at a sample frequency 314 that are passed through RF channelizer 315, which divides the wide band signal(s) into 79 sampled signals/channels (i.e., RxSig_ch1-79, 316) at sample rate 317, where <<. RF channelizer 315 may output up to 79 detected signals to a bank of 79 channel processors 317. Each channel processor may demodulate a signal received from RF channelizer 315 and output the result to packet collector 318 where the individually received packets are stored.

In some embodiments, RF transmitter 320 may include RF front end 322 and basebands 323. RF front end 322 may perform the functions of up conversion and amplification for the simultaneous transmissions of a number of Bluetooth packets via antenna 321. RF front end 322 may include any number of transmitters to support simultaneous transmissions on several channels. Basebands 323 may perform the functions of modulation and coding, as described in the Bluetooth Specification. Basebands 323 may include any number of Bluetooth baseband modules to support transmissions on several channels.

In some embodiments, processing circuitry 330 includes processor 331 and memory module 332. In some embodiments, processing circuitry 330 and/or the processor 331 may include integrated circuitry for processing and/or control, for example, one or more processors, and/or processor cores, and/or Field Programmable Gate Arrays (FPGAs), and/or Application Specific Integrated Circuitry (ASICs), configured to execute programmatic software instructions. In some embodiments, some or all of the functions of RF front end 322 may be performed by the processing circuitry 330. Processing circuitry 330 may be configured to control any of the methods and/or processes described herein and/or to cause such methods and/or processes to be performed, e.g., by packet surveyor 310, baseband 323, and RF front end 322. Memory module 332 may be configured to store data, programmatic software code and/or other information described herein. In some embodiments, the software may include instructions that, when executed by processing circuitry 330, cause processing circuitry 330 to perform the processes described herein with respect to packet surveyor 310 in identifying piconets and controlling RF transmitter 320 in sending blocking transmissions on the piconets' channels.

In some embodiments the functions of wideband front end 312, RF channelizer 315, Channel Processors 317 and Packet Collectors 318 may be performed by one or more processors and/or processor cores and/or FPGAs, and/or ASICs configured to execute programmatic software instructions from processor circuitry 330.

According to an embodiment of the disclosure, a general purpose processor 340 may be used to control the operations of Bluetooth monitoring station 300, and in particular of RF transmitter 320 and packet collectors 318. General purpose processor 340 may provide a user interface via, for example, a keyboard, a mouse, a display, and the like allowing a user to select and input the attributes of the Bluetooth piconet. General purpose processor 340 may also carry out the various calculations as described herein, such as determining when to transmit a signal via RF transmitter 320, based upon a received packet, as reported by a packet collector in packet collectors 318. In some embodiments, general purpose processor 340 may include integrated circuitry for processing and/or controlling, for example, one or more processors, and/or processor cores, and/or FPGAs, and/or ASICs, configured to execute programmatic software instructions, and may further include a memory module to execute programmatic code stored in the general purpose processor 340 or another device. It is also noted that the elements of Bluetooth monitoring station 300 can be included in a single physical device/housing or can be distributed among several different physical devices/housings.

A piconet hops across the 79 channels in an encrypted random manner, hence it is not possible to follow the piconet packets using a single channel Bluetooth receiver. In some embodiments, Bluetooth monitoring station 300 may continuously monitor the 79 channels across the Bluetooth band, detecting packets on any of the 79 channels. On each detected packet, access code 110 may be inspected, and a specific piconet packet and channel may be identified. Bluetooth monitoring station 300 may be configured to search for a number of piconets by searching for a number of pre-determined access codes 110 and subsequently transmitting a blocking signal, via RF transmitter 320, on the same frequency channels of each of the identified piconets. A target access code 110 may be entered by a user via general purpose processor 340 or may be pre-programmed and stored in memory 332. The timing and form of the blocking signal may be entered by a user via general purpose processor 340 or may be pre-programmed and stored in memory 332.

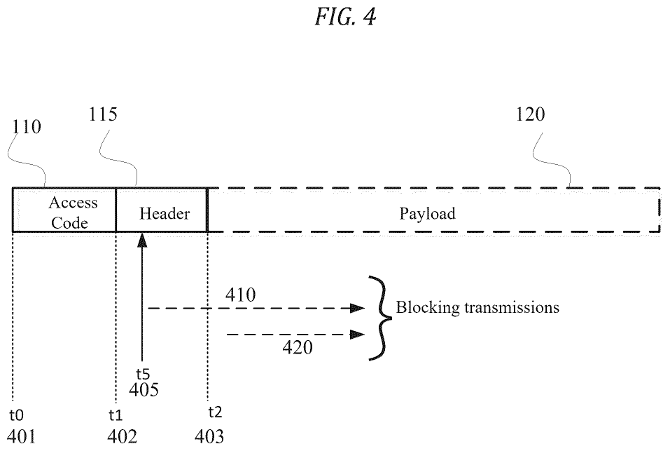

FIG. 4 is a diagram that shows examples of blocking transmissions, 410 and 420, and how they may be transmitted in relation to the timing of a general format 100 of the Classic Bluetooth BR packet type received by the packet surveyor 310, via antenna 311, of Bluetooth monitoring station 300. The start of the reception of the packet 100 may be at time t0 401, which corresponds to the start of the access code 110. Time t0 401 also corresponds to the start of the time slot in which packet 120 is received. At time t1 402, the reception of access code 110 is complete, and reception of Header 115 starts. Time t1 402 is 72 μs after time to 401. At time t2 403, the reception of Header 115 is complete and the reception of the payload 120 starts. Time t2 403 is 54 μs after time t1, 402, and 126 μs after t0, 401. At time t5 405, Bluetooth monitoring station 300 has demodulated the access code 110 and determined the detection of a packet in a specific piconet. Time t5 405 maybe about 77 μs after the start of the access code reception t0 401 e.g., at the reception of the 6th bit of the 54 bit Header 115. Bluetooth monitoring station 300 may continuously receive and demodulate access codes on all 79 channels and determine if one or more pre-selected access codes 110 are present in any packet, on any channel. If so, then Bluetooth monitoring station 300 may transmit one or more blocking transmissions via RF transmitter 320 and antenna 321 on the respective channels of the identified piconets. Generally, the blocking transmission may start at any time after a minimum of 1 μs after time t5 405 and may have any duration within the boundaries of the time slot. In other words, the duration of the blocking transmission cannot extend beyond the end of the time slot.

Although Bluetooth monitoring station 300 can decode the access code 110, it cannot decode the header 115 information as the data is whitened. Bluetooth monitoring station 300 is therefore unable to determine, in real time, the type of packet and the presence of a payload, or the lack thereof. For instance, some packets, such as NULL and POLL packets, do not have a payload and may include just an access code 110 and a Header 115. It is noted that the TDM slot duration is 625 μs, and the maximum payload length is such that certain packet types may extend up to five slots in length. To prevent interference with other piconets, any blocking transmission sent by Bluetooth monitoring station 300 should not extend beyond the end of the packet's time slot in which the target access code 110 is determined. In other words, a blocking transmission may start at any time after 1 μs from time t5 405 but must stop before the time slot ends.

Blocking transmission 410 may be timed to interfere with Header 115, which can cause HEC 215 to fail and the entire packet to be discarded. With 1/3 repetition coding, the HEC field 215 is the last 24 bits of the Header 115. Hence, in order to block HEC 215, blocking transmission 410 may start at least 1 μs after time t5 405, but no later than 24 μs after t5, 405 (i.e., t5+1 μs≤transmission 410 start time≤t5+24 μs). Additionally, blocking transmission 410 may continue at least until time t2 403, which represents the end of the Header 115. Blocking transmission 410 may extend beyond the end of the Header 115, but not beyond the end of the time slot. Therefore the maximum duration for a blocking transmission 410 is 547 μs (i.e., 625−(t5+1)=625−78). Advantageously, Blocking transmission 410 may be used on packets with or without a payload 120, interfering with Header 115 and causing HEC field 215 to fail for packets in a particular piconet. If a Bluetooth device does not receive any packets that pass the HEC check for a set period, the link needs to be reset. A default period for a link reset is 20 seconds. Hence, blocking transmission 410 may be used for a denial of service (DoS) for that piconet by blocking the Header bits on successive packets for a period of at least 20 seconds.

Blocking transmission 420 may be timed to corrupt the payload 120 data but allow the Header 115 to be received intact. Blocking transmission 420 may start no less than 1 μs after t2 403 and continue until the end of the time slot. If a payload is present, then Blocking transmission 420 will corrupt the payload data, which results in “service degradation” (SD) on that piconet. The maximum duration of a Blocking transmission 420 can be 498 μs (i.e., 625−(t2+1)=625−127). NULL and POLL packets remain unaffected by blocking transmission 420.

The start and stop times of blocking transmissions 410 and 420 can be variable and may be pre-programmed and stored in memory 332 in processor circuitry 330, and/or entered by a user via general purpose processor 340.

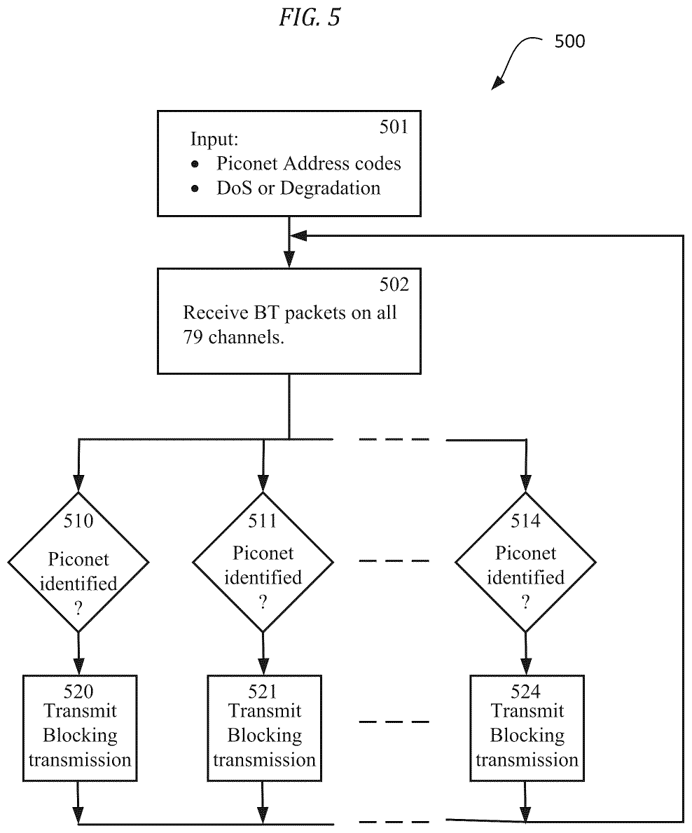

FIG. 5 is a flowchart of an example process 500 of one embodiment of this disclosure for precision blocking of Bluetooth piconets. Process 500 may start at step 501 where the addresses of the target piconets are inputted, and for each address, whether to use denial of service (DoS) or service degradation (SD) against that piconet. The part of the access code 110 that uniquely identifies the piconet is the 24 bit lower address part (LAP) of the master. The LAP is sent as bits 34 to 54 of the access code 110. Hence, at step 501, only the LAPs of the target piconets need be inputted. The LAPs may be inputted by a user (e.g., via the general purpose processor 340) and stored in memory 332 of processing circuitry 330.

At step 502, packets across all 79 channels may be received. All received packets may be processed in channel processors 317 and inputted to packet collectors 318. In steps 510, 511, 514 the access code 110 of any received packet may be examined to check whether it contains an access code that corresponds to the entry in step 501, and if true, generate and transmit blocking transmissions at steps 520, 521, 524. The packet access code examination may be performed by processor circuitry 330, which examines the packets in the packet collectors 318. If there is a match, processor circuitry 330 may cause a blocking transmission to be sent via basebands 323 and RF front end 322.

For example, if at step 501 five target access codes were entered, then processing circuitry 330 may identify, in steps 510, 511, and 514, up to five piconets with a matching access code, and the corresponding channel(s). In this example, step 510 may identify a target piconet, “piconet A”, together with the channel, “channel N” and then at step 520, a blocking transmission is sent, on channel N, corresponding to the setting entered in step 501. If at step 501, “DoS” was entered for piconet A, then, as discussed above with reference to FIG. 4, at step 520, a blocking transmission 410 would be transmitted. Similarly, if at step 511 a target piconet, “piconet B”, is identified, together with the channel, “channel M”, then at step 521, a blocking transmission is sent, on channel M, corresponding to the setting entered in step 501. If at step 501, for example, “service degradation (SD)” was entered for piconet B, then, as discussed above with reference to FIG. 4, at step 520, a blocking transmission 420 would be transmitted via a baseband in basebands 323, RF front end 322, and antenna 321.

The process then returns to step 502. Process 500 is a parallel process because the reception of packets is continuous, and blocking transmissions on one or more channels may occur concurrently as packets on other channels are being received and processed.

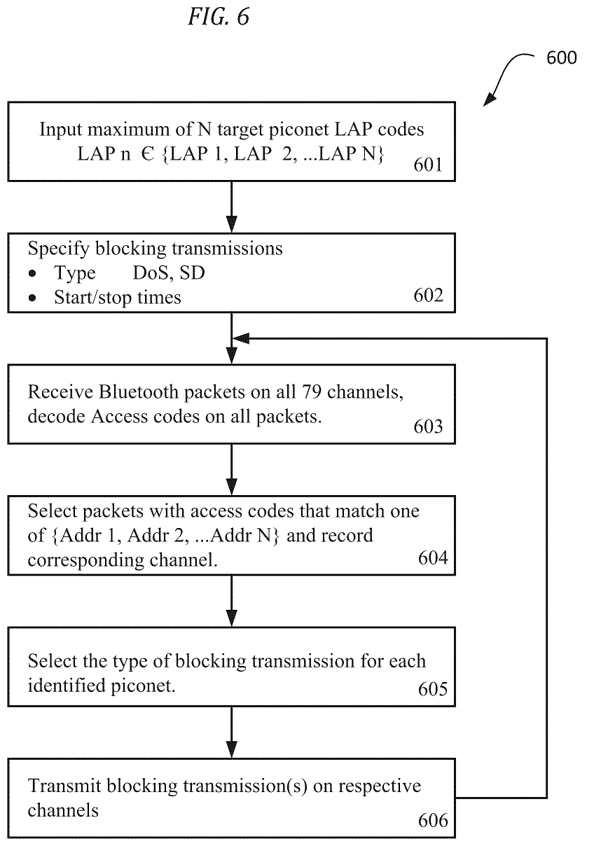

FIG. 6 is a flowchart diagram 600 of another example process for precision blocking of Bluetooth piconets. At step 601 a number of access codes for N target piconets may be entered. For each target piconet, the 24 bit LAP for the master station may be used to uniquely identify that piconet. The LAP is sent as bits 34 to 54 of the access code. The LAPs may be inputted by a user via the general purpose processor 340 and stored in memory 332. At step 602, the parameters of the blocking transmissions may be entered. For example, two types of blocking transmissions may be entered: one for denial of service (DoS) and another for service degradation (SD), as discussed above with reference to FIG. 4. The start and stop times for each blocking transmission type may also be entered. As discussed above with reference to FIG. 4 a DoS blocking transmission 410 may start at a time between 78 μs and 102 μs after the first bit of the access code 110 is received. Blocking transmission 410 stop time may be between 127 μs and the end of the time slot, 625 μs. Although variations in the start and stop times of the DoS blocking transmission 410 are possible, the DoS blocking transmission 410 may be fixed to start at 78 μs after the first bit of the access code is received and stop at the end of the time slot at 625 μs. Because the length of the payload 120 is not known, an SD blocking transmission 420 should start immediately after the end of the header 115 (i.e., 127 μs after the first bit of the access code is received) and stop at the end of the time slot at 625 μs. The start/stop times for the DoS and SD blocking transmissions may be entered by a user via general purpose processor 340 and/or be pre-set, and stored in memory 332.

At step 603, the Bluetooth monitoring station 300 receives packets on all 79 channels, demodulates the access codes 110 in channel processors 317, and passes them to packet collectors 318. The packets may then be inspected and determined if any packet has an access code (i.e., LAP) that matches any of the target piconets entered in step 601. The inspection and selection may be carried out by processing circuitry 330, which reads the LAPs and the channel numbers from the packet collectors 318. At step 605, the blocking transmission for that piconet may be selected, e.g., DoS blocking transmission 410 or SD blocking transmission 420. The selection of blocking transmission (DoS or SD) may be entered for each target piconet by a user via general purpose processor 340. In the alternative, one of the two types may be pre-set and stored in memory 332. In the latter case, all piconets would be subject to the same blocking transmission type, DoS or SD. At step 606, the blocking transmissions are sent. Because the Bluetooth monitoring station 300 is receiving on all 79 channels, if more than one piconet is selected as a target, it is likely that more than one packet would be received, on different channels, at any one time, with matched target access codes (LAPs). Hence, more than one blocking transmission could be sent concurrently on separate channels that may overlap in time. The number of the target piconets may be limited by the number of basebands and transmitters in basebands 323 and RF front end 322 in Bluetooth monitoring station 300. By way of example and not limitation, the number of basebands and transmitters can be 5.

After transmission of the blocking transmission(s) the process may return to step 603. Like process 500, process 600 is a parallel process because the reception of packets is continuous, and blocking transmissions on one or more channels may occur concurrently as packets on other channels are being received and processed.

### SOME EMBODIMENTS

Some embodiments may include any of the following:
A1. A method for precision blocking in Bluetooth target piconets. The method includes receiving a set of target access codes for a set of target piconets; receiving a plurality of packets on a plurality of channels, each packet of the plurality of packets including an access code; decoding the access code for each packet of the plurality of packets on the plurality of channels; identifying, from the plurality of packets, a set of packets whose access codes are within the set of target access codes; estimating, for each identified packet in the set of packets, a start time of a blocking transmission based on a start time of the identified packet; and initiating the blocking transmission at the estimated start time on each channel associated with each identified packet in a target piconet of the set of target piconets.
A2. The method clause A1 can include any of the following components or features, in any combination. The blocking transmission is a DoS blocking transmission that results in a denial of service (DoS) to the target piconet. The DoS blocking transmission is timed to coincide with a header field of the identified packet, causing the identified packet to fail. The DoS blocking transmission starts between 78 and 102 microseconds after a first bit of the identified packet is received and ends between 126 and 625 microseconds after the first bit of the identified packet is received. The DoS blocking transmission is applied for at least 20 seconds to cause a link reset in a target piconet. The blocking transmission is an SD blocking transmission that results in a service degradation (SD) to the target piconet. The SD blocking transmission is timed to start after a header field of an identified packet, causing a payload of the identified packet to fail. The SD blocking transmission starts 127 microseconds after a first bit of the identified packet is received and ends at 625 microseconds after the first bit of the identified packet is received. The SD blocking transmission is applied without affecting a packet lacking a payload, the packet including a NULL packet or a POLL packet.

The method further includes determining a stop time of the blocking transmission based on the start time of the identified packet, where the stop time ensures that the blocking transmission does not extend beyond an end of a time slot in which the identified packet is received. A channel frequency for each of the identified packets is also determined, where the blocking transmission is initiated on the determined channel frequency of each of the identified packets. The plurality of channels includes all channels across a Bluetooth frequency band. Blocking transmissions for two or more target piconets in the set of target piconets are transmitted concurrently on separate channels that overlap in time.

### Additional Considerations

As will be also appreciated by one of skill in the art, the concepts described herein may be embodied as a method, data processing system, and/or computer program product. Accordingly, the concepts described herein may take the form of an entirely hardware embodiment, an entirely software embodiment, or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD ROMs, optical storage devices, magnetic storage devices, or solid state storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on a user's computer, partly on a user's computer, as a stand-alone software package, partly on a user's computer and partly on a remote computer or entirely on the remote computer. In the latter scenario, the remote computer may be connected to a user's computer through a local area network (LAN) or a wide area network (WAN), or the connection may be made to an external computer (for example, through the Internet using an Internet Service Provider).

While the above description contains many specifics, these should not be construed as limitations on the scope, but rather as an exemplification of several embodiments thereof. Many other variants are possible including, for examples: the details of the packet surveyor of the Bluetooth monitoring station, the number of simultaneous blocking transmissions, the start and stop times of the blocking transmissions, the format of the blocking transmissions, the inputting of the LAP or access code.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope.

What is claimed is:

1. A method for precision blocking in Bluetooth target piconets comprising:
receiving a set of target access codes for a set of target piconets;
receiving a plurality of packets on a plurality of channels, wherein each packet of the plurality of packets includes an access code;
decoding the access code for each packet of the plurality of packets on the plurality of channels;
identifying, from the plurality of packets, a set of packets whose access codes are within the set of target access codes;
estimating, for each identified packet in the set of packets, a start time of a blocking transmission based on a start time of the identified packet; and
initiating the blocking transmission at the estimated start time on each channel associated with each identified packet in a target piconet of the set of target piconets.

2. The method of claim 1, wherein the blocking transmission is a DoS blocking transmission that results in a denial of service (DoS) to the target piconet.

3. The method of claim 2, wherein:
the DoS blocking transmission is timed to coincide with a header field of the identified packet, and
the DoS blocking transmission causes the identified packet to fail.

4. The method of claim 3, wherein the DoS blocking transmission starts between 78 and 102 microseconds after a first bit of the identified packet is received and ends between 126 and 625 microseconds after the first bit of the identified packet is received.

5. The method of claim 4, wherein the DoS blocking transmission is applied for at least 20 seconds to cause a link reset in a target piconet.

6. The method of claim 1, wherein the blocking transmission is an SD blocking transmission that results in a service degradation (SD) to the target piconet.

7. The method of claim 6, wherein:
the SD blocking transmission is timed to start after a header field of the identified packet, and
the SD blocking transmission causes a payload of the identified packet to fail.

8. The method of claim 7, wherein the SD blocking transmission starts 127 microseconds after a first bit of the identified packet is received and ends at 625 microseconds after the first bit of the identified packet is received.

9. The method of claim 8, wherein the SD blocking transmission is applied without affecting a packet lacking a payload, the packet including at least a NULL packet or a POLL packet.

10. The method of claim 1, further comprising determining a stop time of the blocking transmission based on the start time of the identified packet, wherein the stop time ensures that the blocking transmission does not extend beyond an end of a time slot in which the identified packet is received.

11. The method of claim 1, wherein blocking transmissions for two or more target piconets in the set of target piconets are transmitted concurrently on separate channels that overlap in time.

12. The method of claim 1, wherein the plurality of channels comprises all channels across a Bluetooth frequency band.

13. The method of claim 1, further comprising determining a channel frequency for each of the identified packets, wherein the blocking transmission is initiated on the determined channel frequency of each of the identified packets.

14. A monitoring system for precision blocking in Bluetooth target piconets, the system comprising:
an antenna configured to receive a plurality of signals on a plurality of channels;
a packet surveyor configured to demodulate each signal in the plurality of signals received on each channel of the plurality of channels and extract an access code from each packet of a plurality of packets contained in the plurality of signals; and
one or more processors configured to:
receive a set of target access codes for a set of target piconets;
identify, from the plurality of packets, a set of packets whose access codes are within the set of target access codes;
estimate, for each identified packet in the set of packets, a start time of a blocking transmission based on a start time of the identified packet; and
initiate the blocking transmission at the estimated start time on each channel associated with each identified packet.

15. The monitoring system of claim 14, wherein the one or more processors are further configured to:
compare the extracted access codes to the set of target access codes to identify the set of packets whose access codes are within the set of target access codes; and
in response to identifying the set of packets, determine a type of the blocking transmission to transmit on a corresponding channel of the plurality of channels, the type comprising at least one of a DoS blocking transmission that causes a denial of service (DoS) and an SD blocking transmission that causes a service degradation (SD).

16. The monitoring system of claim 15, wherein:
the DoS blocking transmission is timed to coincide with a header field of the identified packet, and
the DoS blocking transmission causes the identified packet to fail.

17. The monitoring system of claim 16, wherein the DoS blocking transmission starts between 78 and 102 microseconds after a first bit of the identified packet is received and ends between 126 and 625 microseconds after the first bit of the identified packet is received.

18. The monitoring system of claim 15, wherein:
the SD blocking transmission is timed to start after a header field of the identified packet, and
the SD blocking transmission causes a payload of the identified packet to fail.

19. The monitoring system of claim 18, wherein the SD blocking transmission starts 127 microseconds after a first bit of the identified packet is received and ends at 625 microseconds after the first bit of the identified packet is received.

20. The monitoring system of claim 14, wherein the one or more processors are further configured to transmit blocking transmissions concurrently on a plurality of channels.
